(19) United States
(12) Patent Application Publication
(10) Pub. No.: US 2012/0155673 A1
(43) Pub. Date: Jun. 21, 2012

(54) Compensation Filtering Device and Method Thereof

(76) Inventors: Toshifumi YAMAMOTO, Tokyo (JP); Yasuhiro KANISHIMA, Tokyo (JP)

(21) Appl. No.: 13/218,088

(22) Filed: Aug. 25, 2011

(30) Foreign Application Priority Data
Dec. 17, 2010 (JP) 2010-282248

(51) Int. Cl. H04B 15/00

(52) U.S. Cl. 381/94.1

(57) ABSTRACT

According to one embodiment, a compensation filtering device includes an impulse response calculator, a group delay compensator, and an extractor. The impulse response calculator calculates an impulse response of a reproduction system comprising a sound field. The group delay compensator compensates for group delay characteristics in a low frequency range lower than a predetermined frequency for a finite impulse response (FIR) filter having reverse characteristics of the impulse response based on group delay characteristics in a middle to high frequency range higher than the predetermined frequency. The extractor extracts a predetermined number of taps from the FIR filter that has been compensated for by the group delay compensator.

### CROSS-REFERENCE TO RELATED APPLICATIONS

This application is based upon and claims the benefit of priority from Japanese Patent Application No. 2010-282248, filed Dec. 17, 2010, the entire contents of which are incorporated herein by reference.

### FIELD

Embodiments described herein relate generally to a compensation filtering device and a method thereof.

### BACKGROUND

In various types of conventional AV equipment such as a television, when sound is output, various factors exist that degrade reproduced sound quality of an audio signal. Accordingly, there have been proposed various technologies to output sound with quality faithful to the original.

For example, there has been proposed a technology for compensating for response characteristics in a reproduction system configured to include a sound field using a finite impulse response (FIR) filter. In the FIR filter, the characteristics vary depending on the number of taps constituting the FIR filter and a coefficient indicating a weight for each tap (hereinafter, “tap coefficient”). As the number of taps increases, the frequency resolution of the FIR filter increases and the filter performance improves. However, the larger number of taps increase the arithmetic processing load.

In view of this, there has been proposed a conventional technology for obtaining a filter coefficient of the FIR filter with a limited number of taps. For example, the frequency characteristic is combined with the phase compensation characteristic to obtain a combined compensation characteristic. The combined compensation characteristic is used as the filter coefficient of a compensation filter.

The filter coefficient can be obtained not only by combining the frequency characteristic with the phase compensation characteristic as in the conventional technology, but may be obtained in a different manner.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of an acoustic reproduction device according to an embodiment;

FIG. 2 is an exemplary graph of impulse response of a reproduction system calculated by an impulse response calculator in the embodiment;

FIG. 3 is an exemplary graph of amplitude-frequency characteristics of the impulse response illustrated in FIG. 2 in the embodiment;

FIG. 4 is an exemplary graph of phase-frequency characteristics of the impulse response illustrated in FIG. 2 in the embodiment;

FIG. 5 is an exemplary graph of the tap coefficients of a finite impulse response (FIR) filter indicating reverse characteristics of the impulse response illustrated in FIG. 2 in the embodiment;

FIG. 6 is an exemplary graph of amplitude-frequency characteristics corresponding to the tap coefficients of the FIR filter illustrated in FIG. 5 in the embodiment;

FIG. 7 is an exemplary graph of phase-frequency characteristics corresponding to the tap coefficients of the FIR filter illustrated in FIG. 5 in the embodiment;

FIG. 8 is an exemplary graph of group delay characteristics corresponding to the tap coefficients of the FIR filter illustrated in FIG. 5 in the embodiment;

FIG. 9 is an exemplary graph of tap coefficients of 256 taps extracted by a window function from the tap coefficients of the FIR filter illustrated in FIG. 5 in the embodiment;

FIG. 10 is an exemplary graph of amplitude-frequency characteristics corresponding to the tap coefficients illustrated in FIG. 9 in the embodiment;

FIG. 11 is an exemplary graph of phase-frequency characteristics corresponding to the tap coefficients illustrated in FIG. 9 in the embodiment;

FIG. 12 is an exemplary graph of group delay characteristics corresponding to the tap coefficients illustrated in FIG. 9 in the embodiment;

FIG. 13 is an exemplary graph of group delay characteristics after having been compensated for by a group delay compensator in the embodiment;

FIG. 14 is an exemplary graph of phase-frequency characteristics when group delay characteristics are changed in the embodiment;

FIG. 15 is an exemplary graph of the tap coefficients of the FIR filter after the group delay compensator changes group delay characteristics in the embodiment;

FIG. 16 is an exemplary graph of the tap coefficients of an FIR filter having 256 taps extracted by a tap extractor in the embodiment;

FIG. 17 is an exemplary graph of amplitude-frequency characteristics corresponding to the tap coefficients illustrated in FIG. 16 in the embodiment;

FIG. 18 is an exemplary graph of phase-frequency characteristics corresponding to the tap coefficients illustrated in FIG. 16 in the embodiment;

FIG. 19 is an exemplary graph of group delay characteristics corresponding to the tap coefficients illustrated in FIG. 16 in the embodiment;

FIG. 20 is an exemplary graph of the amplitude-frequency characteristics without compensation for group delay characteristics illustrated in FIG. 10 and the amplitude-frequency characteristics illustrated in FIG. 17 in the embodiment; and

FIG. 21 is an exemplary flowchart of the operation of the acoustic reproduction device to generate a compensation filter in the embodiment.

### DETAILED DESCRIPTION

In general, according to one embodiment, a compensation filtering device comprises an impulse response calculator, a group delay compensator, and an extractor. The impulse response calculator is configured to calculate an impulse response of a reproduction system comprising a sound field. The group delay compensator is configured to compensate for group delay characteristics in a low frequency range lower than a predetermined frequency for a finite impulse response (FIR) filter having reverse characteristics of the impulse response based on group delay characteristics in a middle to high frequency range higher than the predetermined frequency. The extractor is configured to extract a predetermined number of taps from the FIR filter that has been compensated for by the group delay compensator.

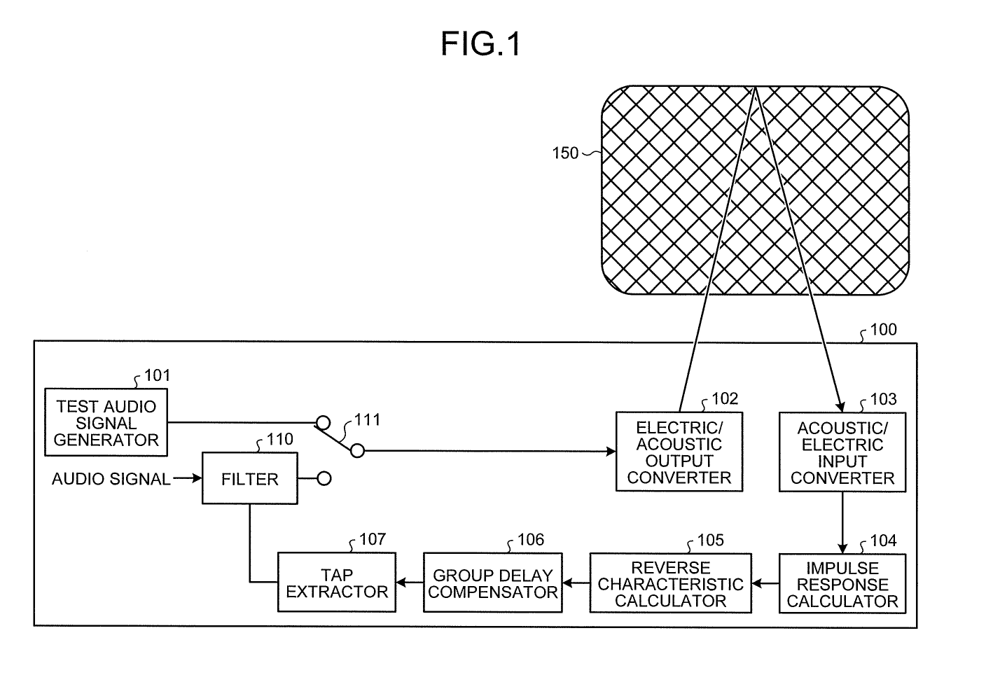

FIG. 1 is a block diagram of an acoustic reproduction device 100 according to an embodiment. As illustrated in FIG. 1, the acoustic reproduction device 100 employs a compensation filtering device that provides acoustic compensation using a filter. The acoustic reproduction device 100 comprises a test audio signal generator 101, an electric/acoustic output converter 102, an acoustic/electric input converter 103, an impulse response calculator 104, a reverse characteristic calculator 105, a group delay compensator 106, a tap extractor 107, a filter 110, and a switch 111.

The switch 111 switches an audio signal output from the acoustic reproduction device 100 between an ordinary audio signal and a test audio signal received from the test audio signal generator 101. More specifically, if a compensation filter is generated, the switch 111 connects between the test audio signal generator 101 and the filter 110. Otherwise, the switch 111 connects between a terminal to output an ordinary audio signal and the filter 110.

The test audio signal generator 101 generates a test audio signal to measure acoustic characteristics (impulse response) of a reproduction system 150 comprising a reproduction sound field. In the embodiment, for example, a white noise signal, a time stretched pulse (TSP) signal, or the like is used as the test audio signal. The test audio signal need not necessarily be generated by the test audio signal generator 101 each time measurement is performed, but may be stored in a memory or the like and read therefrom.

The electric/acoustic output converter 102 converts the test audio signal or an audio signal to be listened to from an electrical signal to reproduction sound and outputs it. The electric/acoustic output converter 102 may comprise a digital/analog converter, a power amplifier, and the like.

The acoustic/electric input converter 103 picks up the test reproduction sound propagating in the reproduction system 150, and converts it from sound to an electrical signal. The acoustic/electric input converter 103 may comprise an analog/digital converter, a power amplifier, and the like.

The impulse response calculator 104 calculates an impulse response of the reproduction system 150 comprising a reproduction sound field from the electrical signal converted from the test reproduction sound.

The reproduction sound emitted from the electric/acoustic output converter 102 to the reproduction system 150 is influenced by natural vibration of the vibration system of the electric/acoustic output converter 102, the divided vibration of a vibration board, a standing wave generated in the housing, or a resonance in the housing. The reproduction sound is further subject to various influences such as duct resonance in the reproduction system 150, the reflection of a grill or a net existing in the reproduction system 150, and the like. Accordingly, the picked up test reproduction sound is disturbed in amplitude-frequency characteristics and phase-frequency characteristics compared to the test audio signal generated by the test audio signal generator 101.

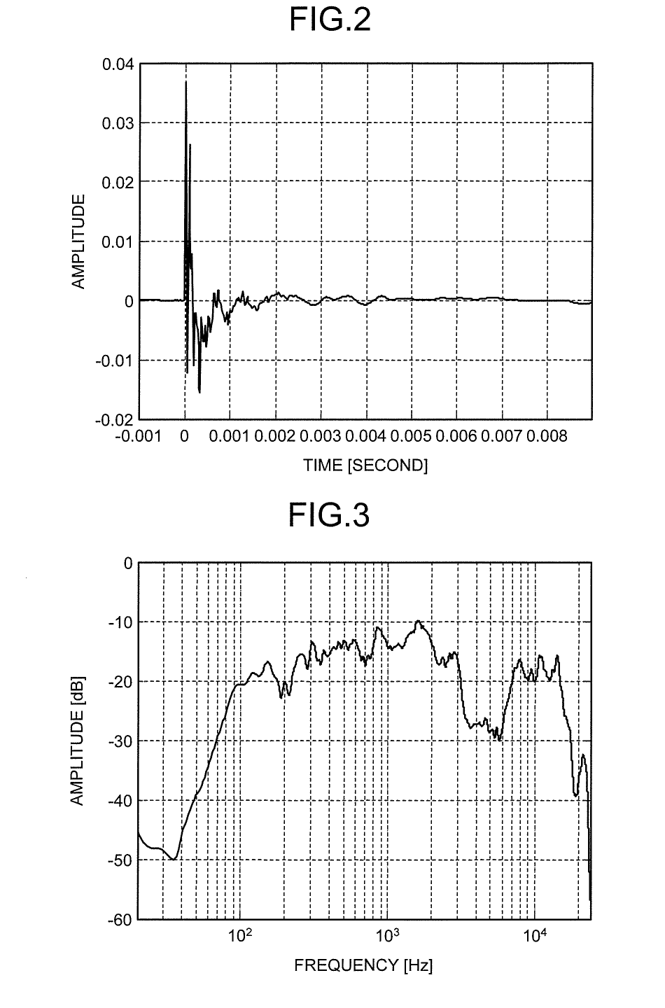

FIG. 2 illustrates a measurement example of the impulse response of the reproduction system 150 calculated by the impulse response calculator 104. In the example of FIG. 2, it is assumed that the sampling frequency is 48 kHz. The impulse response is checked about amplitude-frequency characteristics and phase-frequency characteristics.

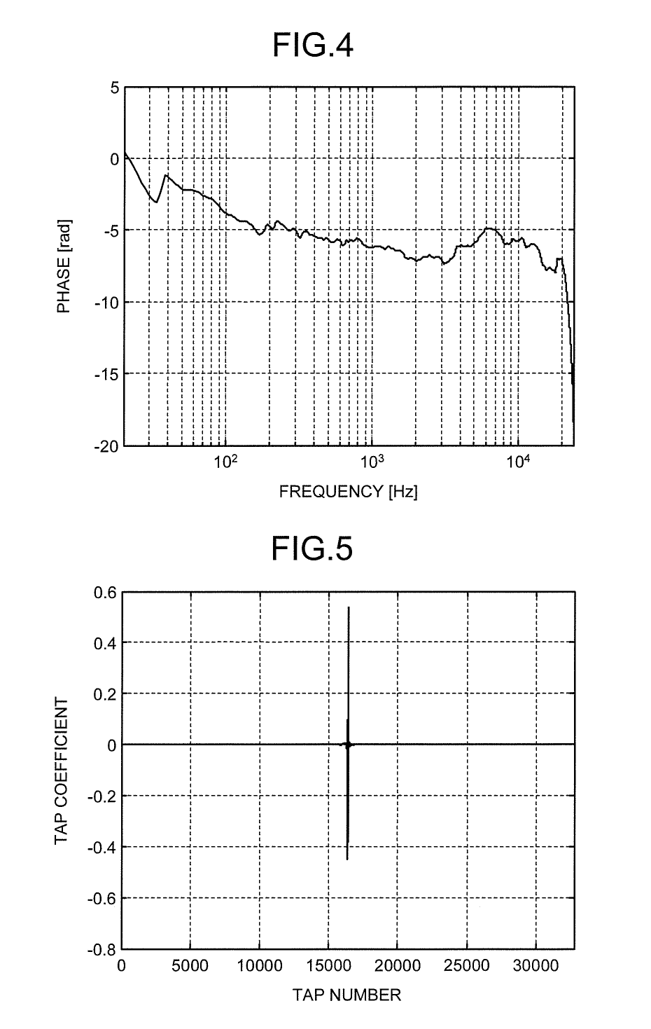

FIG. 3 illustrates the amplitude-frequency characteristics of the impulse response illustrated in FIG. 2. FIG. 4 illustrates the phase-frequency characteristics of the impulse response illustrated in FIG. 2. It can be seen from the example of FIGS. 3 and 4 that the amplitude-frequency characteristics and the phase-frequency characteristics are disturbed.

In view of this, the acoustic reproduction device 100 of the embodiment applies a finite impulse response (FIR) filter to compensation for the acoustic characteristics.

The reverse characteristic calculator 105 calculates the reverse characteristics of the impulse response calculated by the impulse response calculator 104. For example, the reverse characteristic calculator 105 takes the discrete Fourier transform of the impulse response and obtains a complex number in the frequency domain. The reverse characteristic calculator 105 then calculates the inverse number of the complex number and further takes the discrete Fourier transform, thereby obtaining the reverse characteristics of the impulse response.

FIG. 5 illustrates the tap coefficients of the FIR filter indicating the reverse characteristics of the impulse response illustrated in FIG. 2. In the example of FIG. 5, the reverse characteristic calculator 105 sets −20.5 dB as a reference level, and performs the calculation by substituting the reference level −20.5 dB for original amplitude characteristics with respect to a low frequency range of 100 Hz or less and a high frequency range of 15 kHz or more. This calculation is aimed at avoiding a filter having a large compensation gain from being generated in a low frequency range of 100 Hz or less and a high frequency range of 15 kHz or more in spite of the fact that reproduction sound output from the electric/acoustic output converter 102 cannot respond in the frequency ranges. Incidentally, the term “tap coefficient” as used herein refers to a coefficient indicating weight with respect to each tap.

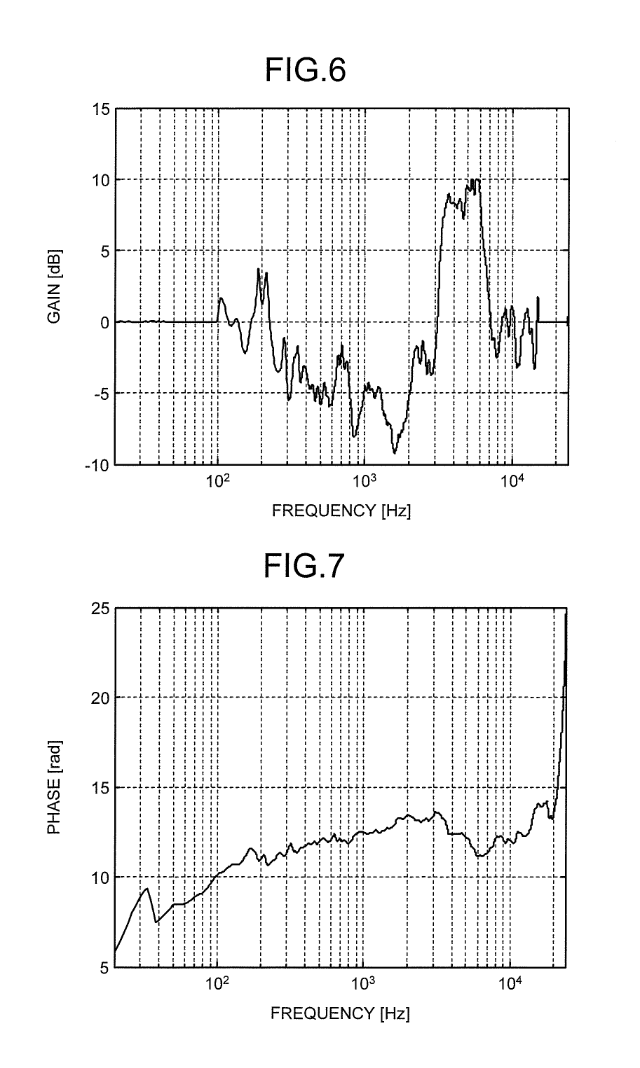

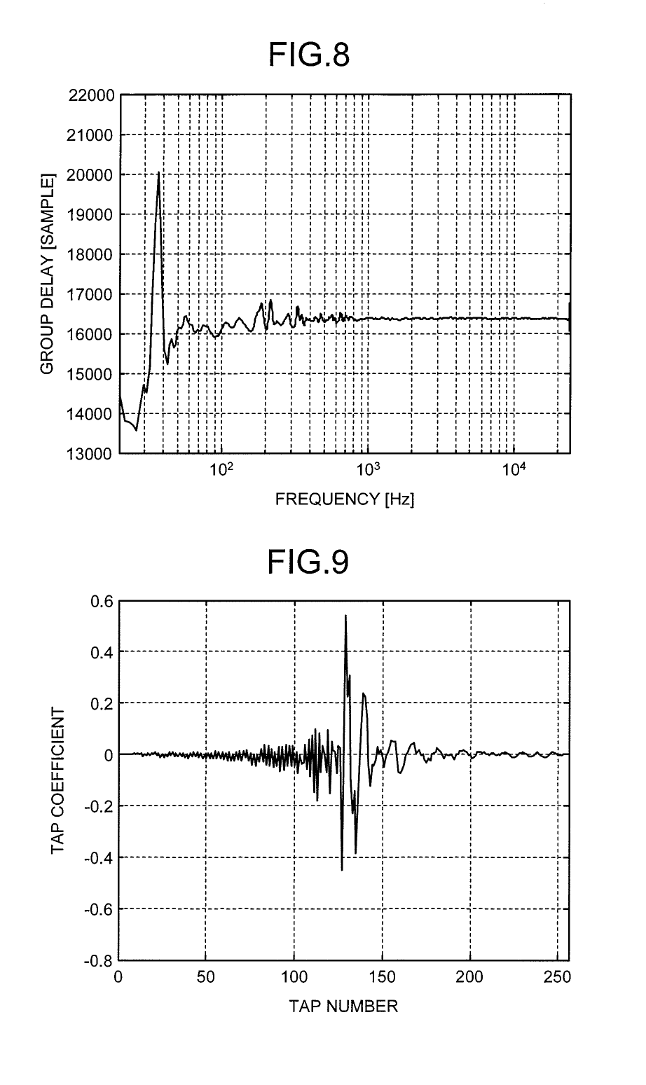

FIG. 6 illustrates amplitude-frequency characteristics corresponding to the tap coefficients of the FIR filter illustrated in FIG. 5. FIG. 7 illustrates phase-frequency characteristics corresponding to the tap coefficients of the FIR filter illustrated in FIG. 5. In the example of FIG. 6, the calculation is performed by substituting the reference level for a low frequency range of 100 Hz or less and a high frequency range of 15 kHz or more. As a result, it can be seen that the gain is 0 dB. FIG. 8 illustrates group delay characteristics corresponding to the tap coefficients of the FIR filter illustrated in FIG. 5.

The amplitude-frequency characteristics illustrated in FIG. 6 represent a compensation gain based on the amplitude level “−20.5 dB” of FIG. 3 indicating amplitude-frequency characteristics of the impulse response of the reproduction system. The characteristic curve approximates characteristics obtained by reversing the amplitude-frequency characteristics of FIG. 3 about “−20.5 dB” as an axis. Thus, with the FIR filter having the tap coefficients as illustrated in FIG. 6, reproduction sound of flat amplitude-frequency characteristics is obtained in the range of 100 Hz to 15 kHz.

Meanwhile, the tap coefficients illustrated in FIG. 5 require substantial time to converge. Therefore, if an FIR filter is generated with the tap coefficients of FIG. 5, this results in a filter of 32768 taps. Such a filter necessitates enormous arithmetic processing and an increase in circuit size and power consumption.

To reduce the taps of the filter, there has been proposed a method in which data is extracted for a predetermined number of taps and installed as a filter. In the embodiment, the tap extractor 107 extracts an FIR filter corresponding to a predetermined number of taps from an FIR filter having reverse characteristics calculated by the reverse characteristic calculator 105.

FIG. 9 illustrates tap coefficients of 256 taps extracted by a window function from the tap coefficients of the FIR filter illustrated in FIG. 5.

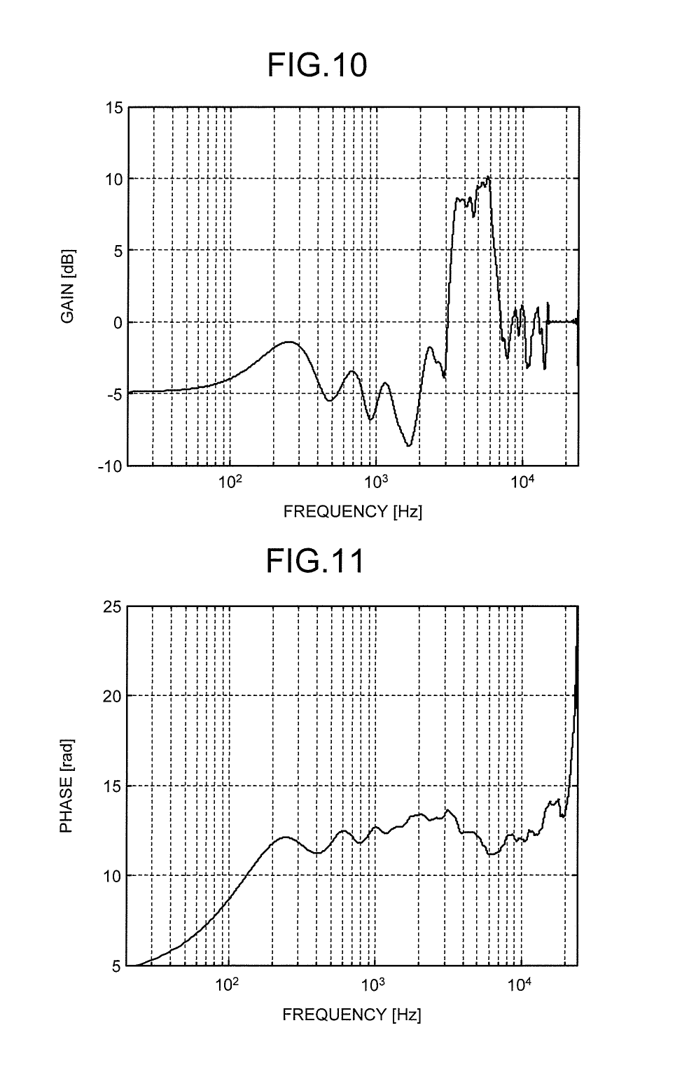

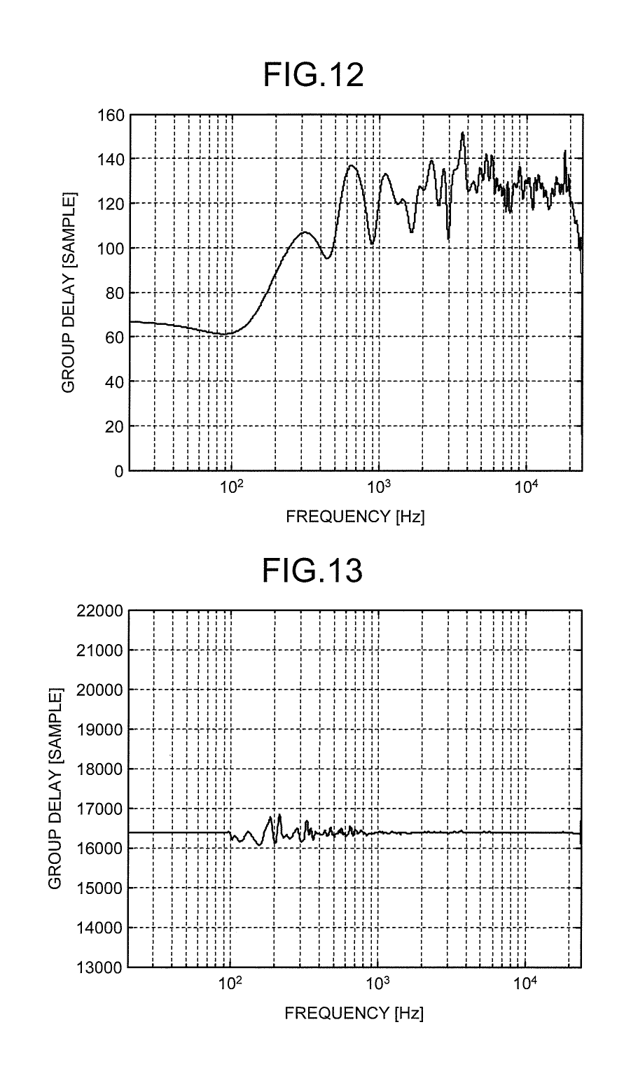

FIG. 10 illustrates amplitude-frequency characteristics corresponding to the extracted tap coefficients illustrated in FIG. 9. FIG. 11 illustrates phase-frequency characteristics corresponding to the extracted tap coefficients illustrated in FIG. 9. FIG. 12 illustrates group delay characteristics corresponding to the extracted tap coefficients illustrated in FIG. 9. It can be seen that, in the amplitude-frequency characteristics of FIG. 10, the gain substantially reduces in the low frequency range compared to the amplitude-frequency characteristics before the extraction illustrated in FIG. 6.

This is based on that impulse response needs more time to converge with an increase in group delay due to the phase rotation of reproduction sound. That is, in the FIR filter, although the convergence time of impulse response is prolonged because of the characteristics to return group delay, extraction is performed with respect to the impulse response, i.e., the number of taps are limited. As a result, components of the low frequency range where the group delay is large are cut off.

For this reason, according to the embodiment, as illustrated in FIG. 9, the group delay compensator 106 compensates for group delay before 256 taps are extracted from the tap coefficients of the FIR filter.

The group delay compensator 106 compensates for group delay characteristics in a low frequency range lower than a predetermined frequency based on group delay characteristics in a middle to high frequency range higher than the predetermined frequency. In the embodiment, an example is described in which a reference frequency that separates the low frequency range and the middle to high frequency range is 100 Hz.

Note that the reference frequency is not limited to 100 Hz. For example, if 256 taps are extracted, it is not possible to control group delay of 256 samples or more. Thus, based on the actual measurement result as illustrated in FIG. 8, the reference frequency may be set as appropriate to compensate for a large group delay. In the embodiment, the reference frequency is described by way of example as being 100 Hz.

The group delay compensator 106 of the embodiment compensates for group delay in a low frequency range of 100 Hz or less such that it matches the value of group delay of the entire impulse response except the low frequency range. FIG. 13 illustrates group delay characteristics after having been compensated for by the group delay compensator 106. As illustrated in FIG. 13, the group delay compensator 106 substitutes group delay in a low frequency range of 100 Hz or less with a predetermined value approximate to the average group delay in a middle to high frequency range higher than 100 Hz. With this, it can be seen that group delay in the low frequency range, which substantially varies with the group delay characteristics as illustrated in FIG. 8, matches group delay in the middle to high frequency range.

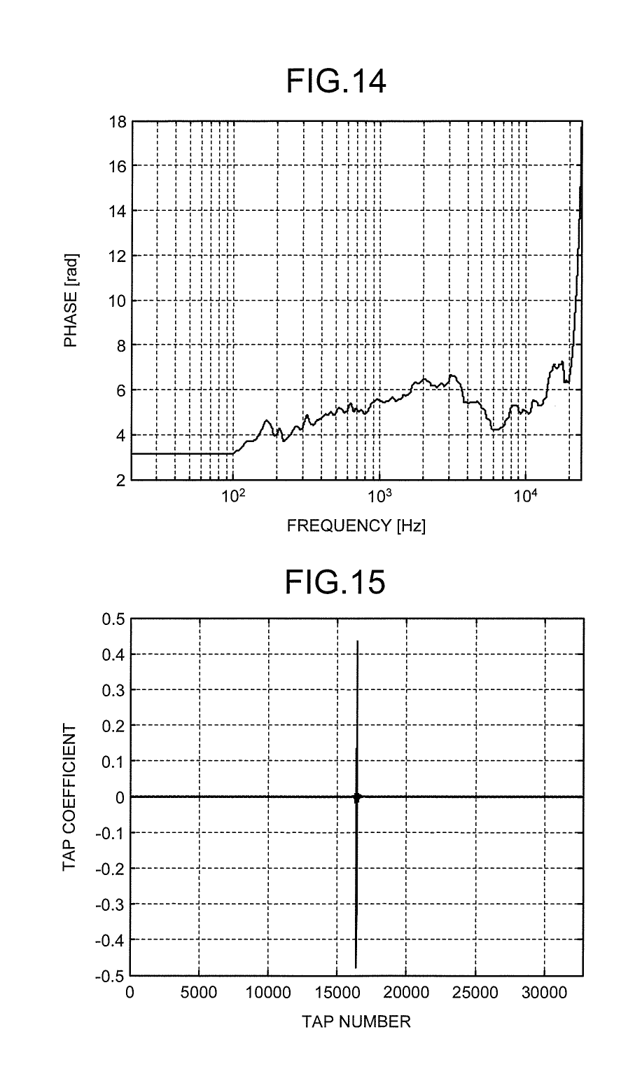

FIG. 14 illustrates phase-frequency characteristics when group delay characteristics are changed. Comparing the phase-frequency characteristics illustrated in FIG. 14 with those of FIG. 7, the phase changes in a narrower range with the phase-frequency characteristics of FIG. 14. Thus, it can be seen that the phase-frequency characteristics of FIG. 14 are more suitable for an FIR filter having a fewer taps compared to those of FIG. 7.

FIG. 15 illustrates the tap coefficients of the FIR filter after the group delay compensator 106 changes group delay characteristics. In the embodiment, the following process is performed using the tap coefficients after the change.

The tap extractor 107 extracts a predetermined number of taps from the FIR filter after the group delay characteristics are compensated for by the group delay compensator 106, and generates a compensation filter. In the embodiment, for example, 256 taps are extracted. To extract 256 taps, the tap extractor 107 uses a window function such as Tukey (tapered cosine) window. Tap coefficients of taps need not necessarily be extracted using a window function such as Tukey (tapered cosine) window, and other techniques may be used.

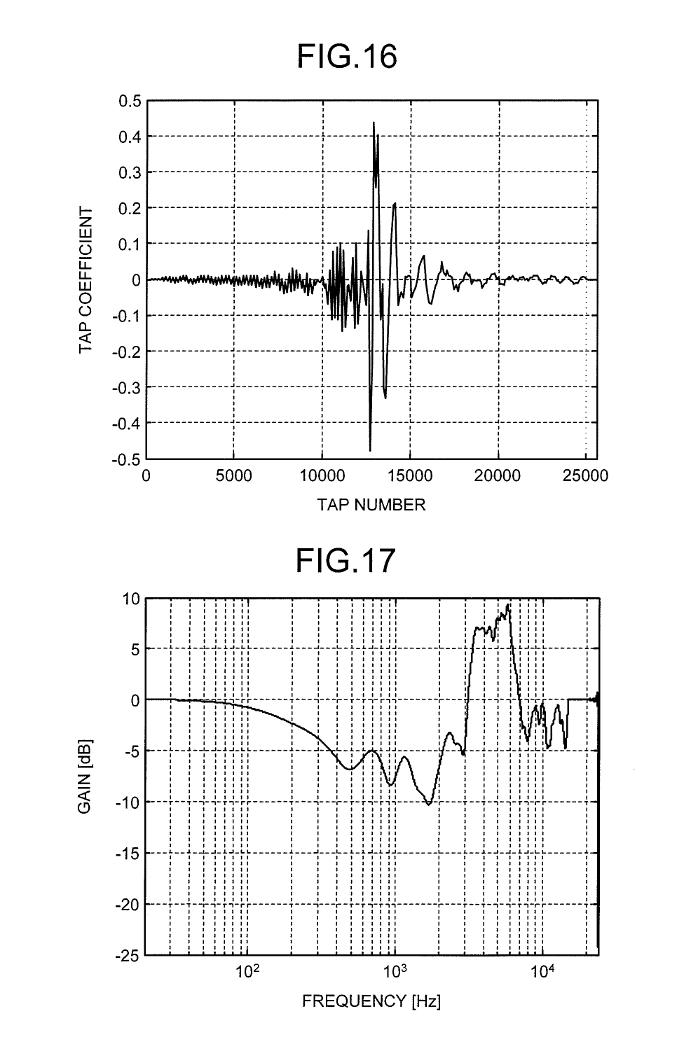

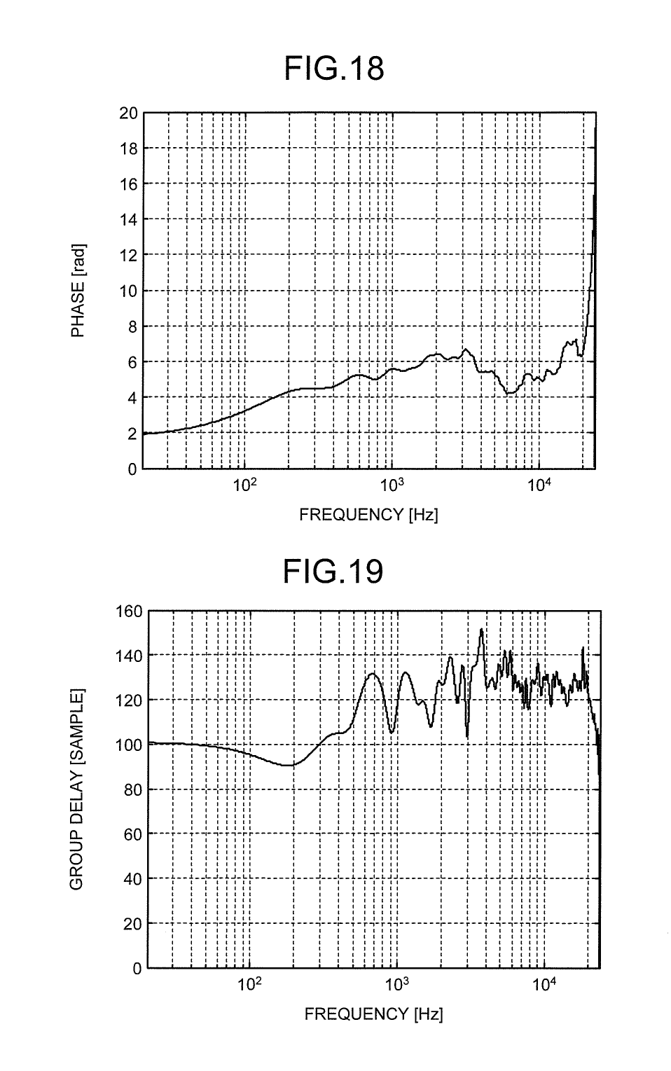

FIG. 16 illustrates the tap coefficients of an FIR filter having 256 taps extracted by the tap extractor 107. FIG. 17 illustrates amplitude-frequency characteristics corresponding to the tap coefficients illustrated in FIG. 16. FIG. 18 illustrates phase-frequency characteristics corresponding to the tap coefficients illustrated in FIG. 16. FIG. 19 illustrates group delay characteristics corresponding to the tap coefficients illustrated in FIG. 16.

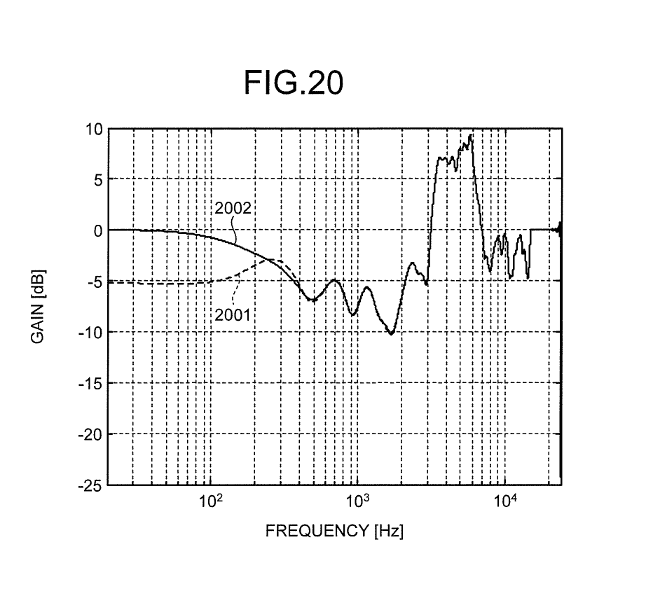

FIG. 20 illustrates the amplitude-frequency characteristics without compensation for group delay characteristics illustrated in FIG. 10 and the amplitude-frequency characteristics illustrated in FIG. 17. In FIG. 20, line 2001 indicates the amplitude-frequency characteristics of the FIR filter extracted by using a window function without compensation for group delay characteristics. Meanwhile, line 2002 indicates the amplitude-frequency characteristics of the compensation filter extracted by using a window function after compensation for group delay characteristics. As illustrated in FIG. 20, the amplitude-frequency characteristics after compensation for group delay characteristics indicated by line 2002 improve in the low frequency range.

The filter 110 performs filtering on an audio signal output from the electric/acoustic output converter 102 using the compensation filter extracted by tap extractor 107.

With this configuration, the acoustic reproduction device 100 of the embodiment can perform appropriate filtering on an audio signal.

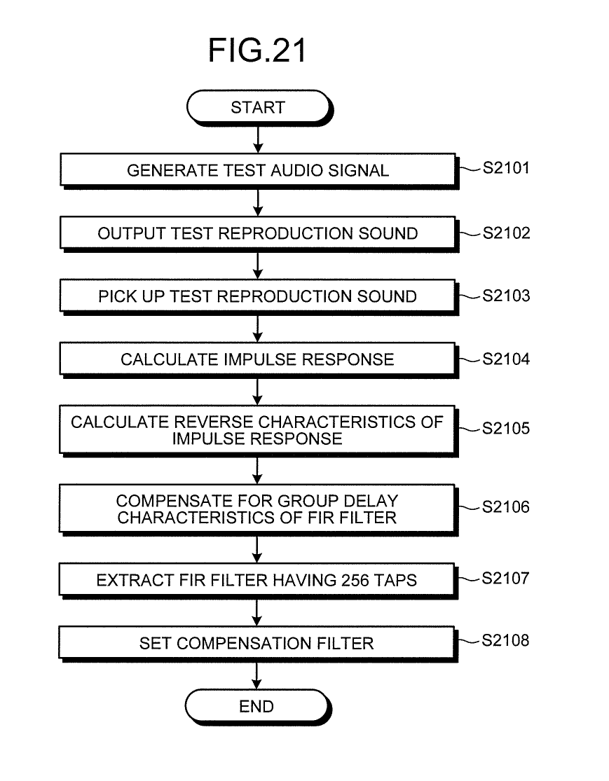

In the following, a description will be given of the operation of the acoustic reproduction device 100 to generate a compensation filter. FIG. 21 is a flowchart of the operation of the acoustic reproduction device 100.

First, the test audio signal generator 101 generates a test audio signal (S2101). The electric/acoustic output converter 102 converts the test audio signal from an electrical signal to reproduction sound and outputs it to the reproduction system 150 (S2102).

The acoustic/electric input converter 103 picks up the test reproduction sound propagating in the reproduction system 150, and converts it from reproduction sound to an electrical signal (S2103).

The impulse response calculator 104 calculates an impulse response of the reproduction system 150 comprising a reproduction sound field from the electrical signal converted from the test reproduction sound (S2104).

The reverse characteristic calculator 105 calculates the reverse characteristics of the impulse response calculated by the impulse response calculator 104 (S2105).

The group delay compensator 106 compensates for group delay characteristics in the low frequency range of the FIR filter, e.g., a frequency range of 100 Hz or less, to match group delay characteristics in the middle to high frequency range, e.g., a frequency range higher than 100 Hz (S2106).

The tap extractor 107 extracts an FIR filter having 256 taps from the FIR filter having the calculated reverse characteristics, and generates a compensation filter to compensate for the acoustic characteristics of the reproduction system (S2107).

The tap extractor 107 sets the generated compensation filter to the filter 110 (S2108).

In this manner, the audio signal is corrected with the compensation filter having filter characteristics in which group delay characteristics are compensated for.

While the acoustic reproduction device 100 of the embodiment is described above as changing group delay characteristics in the low frequency range after the reverse characteristics of measured impulse response are obtained, this is by way of example and not of limitation. For example, the reverse characteristics of measured impulse response may be obtained after group delay characteristics in the low frequency range are changed with respect to the impulse response.

Besides, while an example is described in the embodiment in which group delay in the low frequency range is substituted with a predetermined value to change group delay characteristics, it is not so limited. Group delay characteristics may be changed by any other method of reducing the range of phase change, i.e., reducing group delay time.

If using an FIR filter having a fewer taps, i.e., less arithmetic operations, the acoustic reproduction device 100 of the embodiment can suitably compensate for amplitude characteristics in the low frequency range.

As described above, according to the embodiment, the acoustic reproduction device 100 does not need to additionally have a low-pass filter to set basic sound quality. Thus, it is possible to avoid an increase in arithmetic operations for signal processing and circuit size. Further, the acoustic reproduction device 100 can achieve favorable acoustic pressure characteristics in the low frequency range with less need to rely on acoustic low-frequency enhancement without a cost increase. In other words, the acoustic reproduction device 100 can achieve both processing load reduction and performance improvement of acoustic characteristics.

According to the embodiment, the acoustic reproduction device 100 can suppress a gain drop in the low frequency range by adjusting group delay characteristics of the tap coefficients of the FIR filter. Thus, if using an inexpensive filter having a fewer taps that can be mounted on a digital signal processor (DSP), it is possible to achieve favorable acoustic pressure characteristics in the low frequency range.

While the acoustic reproduction device 100 of the embodiment is described as generating a compensation filter as well as performing filtering using the generated compensation filter, it is not so limited. For example, the acoustic reproduction device may comprise an output module that outputs an audio signal and a filter that performs filtering on the audio signal output from the output module using a compensation filter generated and set by another filtering device in a manner as described above.

While the acoustic reproduction device 100 is described by way of example above as being installed in a television receiver, it may be applied to other devices. For example, the acoustic reproduction device 100 may be applied to an external speaker provided to a personal computer or the like. The acoustic reproduction device 100 may also be applied to acoustic equipment such as compact disc (CD) players. The acoustic reproduction device 100 may be built in a mobile telephone, and may also be applied to headphones.

The acoustic reproduction device 100 installed in a television receiver has a hardware configuration comprising a central processing unit (CPU), a read only memory (ROM), and a random access memory (RAM). A computer program (hereinafter, “acoustic processing program”) can be executed on a computer to realize the same function as the acoustic reproduction device 100 of the above embodiment. The acoustic processing program may be provided as being stored in advance in ROM or the like.

The acoustic processing program comprises modules that implement the above constituent elements (including the test audio signal generator, the electric/acoustic output converter, the acoustic/electric input converter, the impulse response calculator, the reverse characteristic calculator, the group delay compensator, the tap extractor, and the filter). As real hardware, the CPU loads the acoustic processing program from the ROM into the RAM and executes it. With this, the test audio signal generator, the electric/acoustic output converter, the acoustic/electric input converter, the impulse response calculator, the reverse characteristic calculator, the group delay compensator, the tap extractor, and the filter are implemented on the RAM.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A compensation filtering device comprising:
an impulse response calculator configured to calculate an impulse response of a reproduction system comprising a sound field;
a group delay compensator configured to compensate for group delay characteristics in a low frequency range lower than a predetermined frequency for a finite impulse response (FIR) filter with reverse characteristics of the impulse response based on group delay characteristics in a middle to high frequency range higher than the predetermined frequency; and
an extractor configured to extract a predetermined number of taps from the FIR filter that has been compensated for by the group delay compensator.

2. The compensation filtering device of claim 1, wherein the group delay compensator is configured to compensate for the group delay characteristics in the low frequency range with a predetermined value approximate to the average of the group delay characteristics in the middle to high frequency range.

3. The compensation filtering device of claim 1, further comprising:
an output module configured to output an audio signal; and
a filter configured to perform filtering on the audio signal output from the output module with the FIR filter having the predetermined number of taps extracted by the extractor.

4. The compensation filtering device of claim 1, further comprising a reverse characteristic calculator configured to calculate reverse characteristics of the impulse response calculated by the impulse response calculator, wherein
the group delay compensator is configured to compensate for the group delay characteristics in the low frequency range for the FIR filter with the reverse characteristics calculated by the reverse characteristic calculator based on the group delay characteristics in the middle to high frequency range.

5. A compensation filtering device comprising:
an output module configured to output an audio signal; and
a filter configured to, after compensating for group delay characteristics in a low frequency range lower than a predetermined frequency for a finite impulse response (FIR) filter with reverse characteristics of an impulse response of a reproduction system comprising a sound field based on group delay characteristics in a middle to high frequency range higher than the predetermined frequency, perform filtering on the audio signal output from the output module using the FIR filter having a predetermined number of taps extracted as a compensation filter.

6. A compensation filtering method comprising:
calculating, by an impulse response calculator, an impulse response of a reproduction system comprising a sound field;
compensating for, by a group delay compensator, group delay characteristics in a low frequency range lower than a predetermined frequency for a finite impulse response (FIR) filter with reverse characteristics of the impulse response based on group delay characteristics in a middle to high frequency range higher than the predetermined frequency; and
extracting, by an extractor, a predetermined number of taps from the FIR filter that has been compensated for by the group delay compensator.
